(19) United States
(12) Patent Application Publication
(10) Pub. No.: US 2014/0224960 A1
(43) Pub. Date: Aug. 14, 2014

(54) THREE-DIMENSIONAL BAKING MOULD FOR PRODUCING BAKED GOODS

(71) Applicant: W.F. Kaiser u. Co. GmbH, Diez (DE)

(72) Inventor: Joerg Lindemann, Goergeshausen (DE)

(73) Assignee: W.F. Kaiser u. Co. GmbH, Diez (DE)

(21) Appl. No.: 14/174,397

(22) Filed: Feb. 6, 2014

(30) Foreign Application Priority Data
Feb. 13, 2013 (DE) 10 2013 202 308.1

(51) Int. Cl. A21B 3/13

(52) U.S. Cl. CPC A21B 3/13
USPC 249/168; 249/173

(57) ABSTRACT

A three-dimensional baking mould (1) for producing baked goods, has a first negative mould part (2) and a second negative mould part (3), which form the baking mould (1) when fastened to each other. The two mould parts (2, 3) form a cavity (4), into which dough can be introduced through a receiving opening (5), which is partially formed by each of the two mould parts (2, 3). The first mould part (2) can be fastened to the second mould part (3) by at least one fastening element (6), preferably by means of two fastening elements (6), consisting of silicone.

### BACKGROUND

1. Field of the Invention

The invention relates to a three-dimensional baking mould for producing baked goods.

2. Description of the Related Art

Three-dimensional baking moulds are used for baking cakes, gateaus, pastries and other baked goods. The main purpose of baking moulds is to prevent doughs such as stirred and biscuit mixtures, which are soft owing to their high liquid or fat content, or fat-rich fillings from spreading until the mass has solidified.

Conventional three-dimensional baking moulds are often formed in two pieces with a first and a second negative mould part, which can be fastened to each other and produce the desired negative mould when fastened to each other. The two mould parts have such a geometry that they together form a cavity into which the dough necessary to produce the baked goods can be introduced through a receiving opening. The receiving opening can be partially formed by each of the two mould parts. After a baking process in a baking oven has finished, the two mould parts which are fastened to each other are separated from each other again so that they release the baked product which has been solidified by the baking process.

The present invention is concerned with the problem of specifying an improved embodiment for a three-dimensional baking mould, which is characterised in particular by simple handling.

### SUMMARY OF THE INVENTION

The invention is based on the general concept of fastening two mould parts, which produce a baking mould, to each other by means of at least one fastening element, preferably by means of two fastening elements, consisting of silicone. Such a fastening element consisting of silicone is suitable for fastening the two negative mould parts to each other in a simple yet stable manner, so that the two mould parts form the cavity necessary for filling with dough and close the latter off reliably from the environment towards the outside—with the exception of the receiving opening. The fastening elements (silicone clamps) hold the baking mould together correspondingly during baking and are used for simplified handling/fastening. The use of silicone as a material for the fastening element ensures that the latter has the heat resistance necessary for a baking process in an oven. At the same time, silicone is a material which is very resistant to domestic detergents, so the fastening element produced from silicone is in particular suitable for cleaning processes in a dishwasher.

Preferably, the at least one fastening element can be formed in the manner of a silicone clamp with two clamp arms, which press a respective fastening region of the two mould parts against each other when the baking mould is in the assembled state. In this manner, a contact pressure between the two mould parts, which is necessary to seal off the cavity formed by the two mould parts from the environment, is ensured between the two mould parts.

To be able to provide the contact pressure to be generated by the fastening element in order to press together the two mould parts in a secure, in particular fluid-tight manner in a simple and thus cost-effective manner, the two clamp arms can be resilient and prestressed against the two mould parts when the baking mould is assembled. According to this embodiment, the two clamp arms therefore press the two mould parts against each other by exerting a spring force.

In an advantageous development, the two mould parts can each have at least one plate-like contact region, the contact regions bearing against each other, preferably in a gap-free manner, when the baking mould is assembled. The contact region can preferably be formed in a complementary manner to a region forming the cavity, in which the respective mould part has a three-dimensional surface contour, i.e. the said two regions complement each other to form the whole negative mould part. The actual shape of the baked product is defined by the three-dimensional surface contour. It can have for example the shape of a gateau, a fire engine or an animal or the like.

Since the two mould parts bear against each other, preferably in a gap-free manner, in the contact region, the two contact regions act in the manner of a seal for the cavity, which seals off the latter from the environment. It can thus be ensured that the ingredients introduced into the cavity via the receiving opening cannot escape in an undesirable manner through a gap between the two mould parts into the environment.

In an advantageous development, the two mould parts can each have a collar-like fastening edge, which projects orthogonally from the fastening region of the mould part and to which the fastening element can be fastened in order to fasten the two mould parts. This allows particularly simple fastening of the fastening element to the mould parts. The collar-like fastening edge and the fastening element can thus be formed in such a manner that the fastening element can be pushed onto the two fastening edges of the mould parts in the manner of a C-shaped strip after the two mould parts have been brought into contact with each other to assemble the baking mould.

For the purpose of particularly stable fastening of the two mould parts, in particular during a filling process of the cavity with the dough, in a particularly expedient embodiment, the two clamp arms of the silicone clamp can be formed in such a manner that they form a form-fitting connection with the two mould parts when the baking mould is assembled.

In an embodiment which is technically particularly simple and thus inexpensive to produce, the silicone clamp can be formed as a profiled strip, which has a profile which is open on one side with an essentially C-shaped contour. According to this embodiment, the two clamp arms engage at least partially behind the collar-like fastening edges of the two mould parts when the baking mould is assembled.

In an advantageous development, the two mould parts can each have a foot region, which projects orthogonally from the fastening region of the mould parts, and by means of which the baking mould can be erected when in the assembled state. The receiving opening of the cavity is preferably arranged on a side of the mould parts opposite the foot region, so that the cavity of the baking mould can be filled in a simple and convenient manner through the upward facing receiving opening when in the erected state.

The silicone can preferably have a heat resistance of at least 250° C. This ensures that the fastening element cannot be damaged by heat even at the high temperatures of up to 250° C. and more occurring in baking ovens during the baking process.

The invention also relates to a fastening element, in particular a clamp element, consisting of silicone for fastening two mould parts of a baking mould, having one or a plurality of the above-mentioned features.

The fastening element can preferably be formed as a profiled strip with a C-shaped cross section. This allows simple yet mechanically stable fastening of the fastening element to the two fastening edges of the two mould parts.

Further important features and advantages of the invention can be found in the subclaims, the drawings and the associated description of the figures using the drawings.

It is self-evident that the above-mentioned features and those still to be explained below can be used not only in the combination given in each case but also in other combinations or alone without departing from the scope of the present invention.

A preferred exemplary embodiment of the invention is shown in the drawings and is explained in more detail in the description below.

### BRIEF DESCRIPTION OF THE DRAWINGS

FIG. 1 schematically shows a perspective view of a three-dimensional baking mould according to the invention,

FIG. 2a schematically shows the three-dimensional baking mould in a plan view,

FIG. 2b schematically shows the fastening element in partial view showing an enlarged illustration,

FIG. 3 schematically shows the three-dimensional baking mould in a side view.

### DETAILED DESCRIPTION OF THE PREFERRED EMBODIMENTS

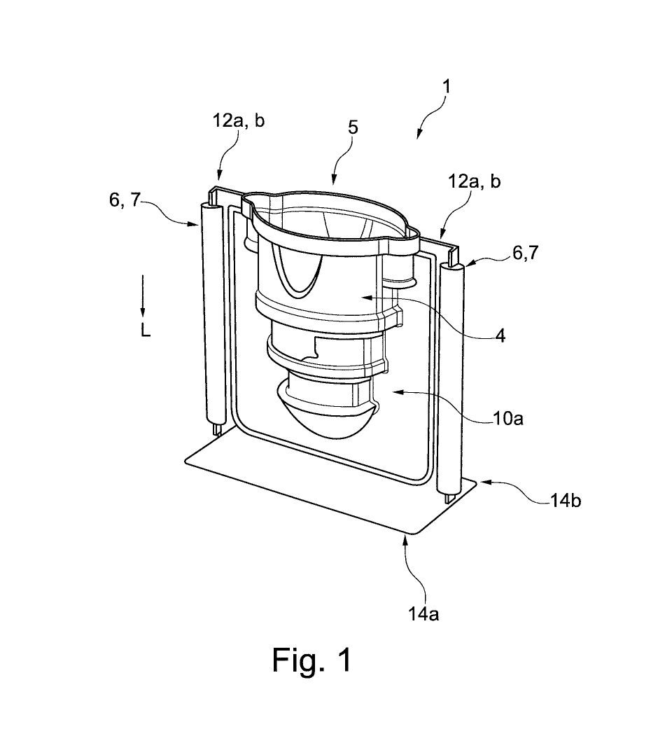

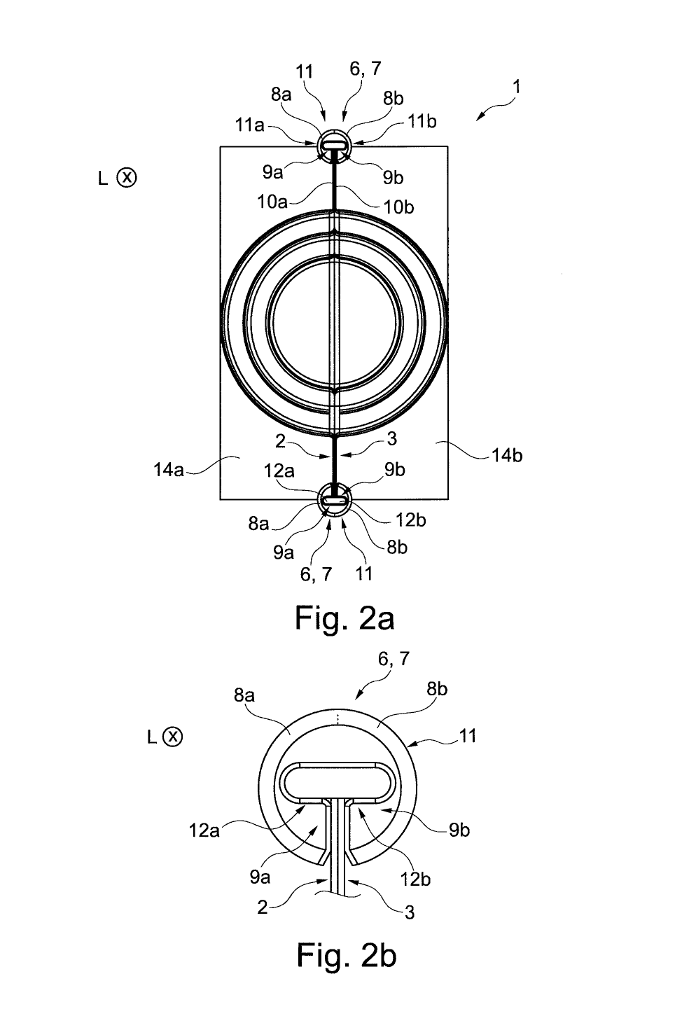

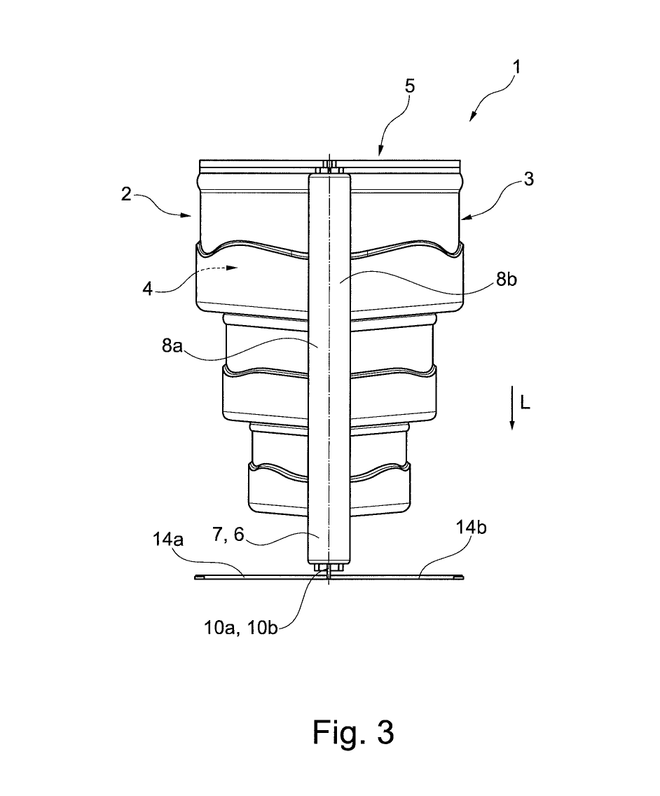

In FIG. 1, a three-dimensional baking mould for producing baked goods is shown in a perspective view and labelled with reference symbol 1. FIGS. 2a and 2b show the baking mould 1 schematically in a plan view, FIG. 3 shows it in a side view. The three-dimensional baking mould 1 comprises a first negative mould part 2 and a second negative mould part 3, as shown in the diagram of FIGS. 2 and 3. The two mould parts 2, 3 produce the baking mould 1 when fastened to each other. When fastened together, the two mould parts 2, 3 form a cavity 4 into which the dough necessary to produce the baked goods can be introduced through a receiving opening 5. The receiving opening 5 is partially formed by each of the two mould parts 2, 3.

The two mould parts 2, 3 can each have a plate-like contact region 10a, 10b (cf. FIG. 1), the contact regions 10a, 10b bearing against each other in a gap-free manner when the baking mould 1 is assembled. Since the two mould parts 2, 3 bear against each other in an essentially gap-free manner in the contact region 10a, 10b, the two contact regions 10a, 10b act in the manner of a sealing element for the cavity 4, which seals off the latter from the environment. It can thus be ensured that the dough introduced into the cavity 4 via the receiving opening 5 cannot escape in an undesirable manner through a gap between the two mould parts 2, 3 into the environment.

When the three-dimensional baking mould 1 is assembled as shown in FIGS. 1 to 3, the first mould part 2 is fastened to the second mould part 3 by means of two fastening elements 6 consisting of silicone (cf. FIG. 2a). The fastening element 6 consisting of silicone is suitable for the simple yet stable fastening of the two negative mould parts 2, 3 to each other, so that the two mould parts 2, 3 form the cavity 4 and can seal off from the environment towards the outside, so that nothing escapes from the cavity during filling of the cavity 4 with dough and also during the actual baking process.

The use of silicone as a material for the fastening element 6 ensures that the latter has the heat resistance necessary for a baking process. At the same time, silicone is a material which is very resistant to domestic detergents, so the fastening element 6 can for example also be cleaned in a dishwasher, separately or as part of the whole baking mould 1. The silicone used for the fastening element 6 can have a heat resistance of at least 250° C., which ensures that the fastening element 6 cannot be damaged by heat even at very high temperatures of up to 250° C. and more occurring in baking ovens during the baking process.

The fastening element 6 can be formed in the manner of a silicone clamp 7 with two clamp arms 8a, 8b, which press a respective fastening region 9a, 9b of the two mould parts 2, 3 against each other when the baking mould 1 is in the assembled state. The fastening element 6 is shown in an enlarged manner in FIG. 2b, which shows a partial view of FIG. 2a. In the respective fastening region 9a, 9b, the two mould parts 2, 3 are each plate-shaped, so a main plane of the respective mould parts 2, 3 is defined by the fastening region 9a, 9b. The two clamp arms 8a, 8b can be resilient and prestressed against the two mould parts 2, 3 when the baking mould 1 is assembled. A contact pressure is generated between the two mould parts 2, 3 by means of the two clamp arms 8a, 8b, which contact pressure ensures that the cavity 4 formed by the two mould parts 2, 3 is sealed off from the environment.

If the diagram of FIG. 2 is viewed, it can be seen that the two clamp arms 8a, 8b of the silicone clamps 7 are formed in such a manner that they form a form-fitting connection to the two mould parts 2, 3 when the baking mould 1 is in the assembled state shown in FIG. 2a/b. To this end, the two mould parts 2, 3 can, as shown in FIG. 2b, each have a collar-like fastening edge 12a, 12b, which projects orthogonally from the fastening region 9a, 9b, and to which the fastening element 6 formed as a silicone clamp 7 can be fastened to fasten the two mould parts 2, 3. This allows particularly simple fastening of the fastening element 6 to the mould parts 2, 3.

The silicone clamp 7 can be formed as a profiled strip 11 (cf. FIG. 2b), which has a profile which is open on one side with an essentially C-shaped cross section, i.e. the profiled strip 11 has an essentially C-shaped cross section. The two fastening edges 12a, 12b can have a T-shaped profile in cross section when the baking mould 1 is assembled. As shown in FIG. 2b, the two clamp arms 8a, 8b engage behind the collar-like fastening edges 12a, 12b of the two mould parts 2, 3 when the baking mould 1 is assembled. In a configuration of the silicone clamp 7 as a profiled strip 11, the latter can be pushed onto the two collar-like fastening edges 9a, 9b of the mould parts 2, 3 along the longitudinal direction L after the two mould parts 2, 3 have been brought into contact with each other to assemble the baking mould 1.

The two mould parts 2, 3 can each have a foot region 14a, 14b, which is shown in FIGS. 2a and 3 and projects orthogonally from an edge region of the mould parts 2, 3, and by means of which the baking mould 1 can be erected when in the assembled state. This allows convenient positioning of the baking mould 1 in a baking oven or the like to carry out the baking process. The receiving opening 5 of the cavity 4 is preferably arranged on a side of the mould parts 2, 3 opposite the foot region 14a, 14b, so that the cavity 4 of the baking mould 1 can be filled in a simple and convenient manner through the upward facing receiving opening 5 when in the erected state.

What is claimed is:

1. A three-dimensional baking mould (1) for producing baked goods,
having a first negative mould part (2) and a second negative mould part (3), which form the baking mould (1) when fastened to each other,
wherein the two mould parts (2, 3) delimit a cavity (4), into which dough can be introduced through a receiving opening (5), which is partially formed by each of the two mould parts (2, 3), wherein
the first mould part (2) can be fastened or is fastened to the second mould part (3) by at least one fastening element (6) made of silicone.

2. The baking mould (1) of claim 1, wherein
the at least one fastening element (6) is a silicone clamp (7) with two clamp arms (8a, 8b), that press respective fastening regions (9a, 9b) of the two mould parts (2, 3) against each other when the baking mould (1) is assembled.

3. The baking mould (1) of claim 2, wherein
the two clamp arms (8a, 8b) are resilient and prestressed against the two mould parts (2, 3) and press the said two parts (2, 3) against each other by exerting a spring force when the baking mould (1) is assembled.

4. The baking mould (1) of claim 2, wherein
the two mould parts (2, 3) each have at least one plate-like contact region (10a, 10b), the contact regions (10a, 10b) bearing against each other in a gap-free manner when the baking mould (1) is assembled.

5. The baking mould (1) of claim 2, wherein
the two mould parts (2, 3) each have a collar-like fastening edge (12a, 12b) that projects orthogonally from the fastening region (9a, 9b) of the mould part (2, 3), and to which the fastening element (6) can be fastened to fasten the two mould parts (2, 3).

6. The baking mould (1) of claim 2, wherein
the two clamp arms (8a, 8b) of the silicone clamp (7) form a form-fitting connection to the two mould parts (2, 3) when the baking mould (1) is assembled.

7. The baking mould (1) of claim 6,
characterised in that
the silicone clamp (7) is a profiled strip (11),
the profiled strip (11) has a profile that is open on one side with an essentially C-shaped cross section,
the two clamp arms (8a, 8b) engage at least partially around collar-like fastening edges (12a, 12b) of the two mould parts (2, 3) when the baking mould (1) is assembled.

8. The baking mould (1) of claim 1, wherein
the silicone has a heat resistance of at least 250° C.

9. A fastening element (6) is formed from silicone for fastening two mould parts (2, 3) of the baking mould (1) of claim 1.

10. The fastening element (6) of claim 9, wherein
the fastening element (6) is formed as a profiled strip (11) with a C-shaped cross section.
